(19) United States
(12) Patent Application Publication
(10) Pub. No.: US 2006/0173822 A1
(43) Pub. Date: Aug. 3, 2006

(54) System and method for optimization of results based on monetization intent

(75) Inventors: Eric B. Watson, Redmond, WA (US); Erik W. Selberg, Seattle, WA (US); Nicole A. Hamilton, Redmond, WA (US)

Correspondence Address: SHOOK, HARDY & BACON L.L.P.;(c/o MICROSOFT CORPORATION), 2555 GRAND BOULEVARD, KANSAS CITY, MO, 64108-2613, US

(73) Assignee: Microsoft Corporation, Redmond, WA (US)

(21) Appl. No.: 11/048,719

(22) Filed: Feb. 3, 2005

(51) Int. Cl. G06F 17/30

(52) U.S. Cl. 707/3

(57) ABSTRACT

A method and system are provided for determining a query monetization value and optimizing results based on the determined monetization value. A system may be provided that includes implementing a search engine for producing search results in response to an input query transmitted to the search engine, wherein the input query including at least one keyword. The system may include monetization determination components for determining a monetization value of the input query. The monetization components may also determine a monetization value of result pages produced by the search engine. The system may further include result modification components for modifying search results produced by the search engine based on the determined monetization values.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to a technique for optimizing search results. In particular, embodiments of the invention relate to a technique for optimizing search results based on knowledge of monetization intent.

### BACKGROUND OF THE INVENTION

Through the Internet and other networks, users have gained access to vast amounts of information distributed over a large number of computers. In order to access the vast amounts of information, users typically implement a user browser to access a search engine. The search engine responds to an input query by returning one or more sources of information available over the Internet or other network.

Currently, when implementing a search engine, a user enters a query including one or more keywords and receives a set of results. Depending upon the particular query entered by a user, the search engine produces a number of results, which are displayed in an order of relevance determined by the search engine. In operation, the search engine typically implements a crawler to access a plurality of websites and stores references to those websites in an index. The references in the index may be categorized based on one or more keywords. When responding to the query, the search engine may first traverse the index in order to locate the input query terms.

Some search engines are linked to advertising systems that allow advertisers to bid on keywords. For instance, advertisers may bid on names for the types of products that they sell. The keywords and bids are stored in the advertising system linked to the search engine. Thus, each query that includes a keyword or series of keywords on which an advertiser has bid will generate an advertisement from the bidding advertiser. If a user selects the advertisement, the advertiser is required to pay the amount of the bid. Bids placed by advertisers may be viewed as reflecting a monetary or “monetization” value of the keywords. Thus, the advertising system knows which keywords trigger advertisement displays and how much each keyword is worth.

Keywords having high monetization intent may result in excessive advertising spam and an inadequate user experience. In response to a query, search engines may produce results in two forms, based on advertising bids and algorithmic relevance. While many advertisers legitimately bid for keywords, others, unwilling to pay the advertising bid, may attempt to bypass the advertising system entirely and falsely promote their pages in the algorithmic results. This may most often occur when high monetization values are involved and may result in an inferior customer experience.

Today, search engines do not characterize queries as commercial or non-commercial. Therefore, when generating results, search engines do not separate those queries that have a high monetization intent from those queries that do not have a high monetization intent. The higher the total dollar sum of the bids for a given keyword, the more commercial the keyword is likely to be, or the higher the monetization for the keyword. The number of advertisements that is generated by the advertising system for a keyword is also an indicator of the degree of monetization. The advertising system can give the search engine an idea of whether a keyword or set of keywords forms a highly monetized query. Thus, a solution is needed that improves the user experience for queries having high monetization intent, based on available knowledge of this intent.

### BRIEF SUMMARY OF THE INVENTION

Embodiments of the present invention are directed to a method for implementing a search engine for producing search results in response to an input query transmitted to the search engine. The method may include determining a query monetization value for the input query and assessing whether a search result presentation determined by the search engine requires modification based on the determined query monetization value. In some embodiments, the method may include determining a monetization value for each page contained within an index.

In an additional aspect, a system is provided for implementing a search engine for producing search results in response to an input query transmitted to the search engine, the input query including at least one keyword. The system may include monetization determination components for determining a monetization value of at least one of the input query and result pages produced by the search engine. The system may additionally include result modification components for modifying search results produced by the search engine based on the determined monetization value.

In yet a further aspect, a method is provided for implementing a search engine for producing search results in response to an input query transmitted to the search engine. The method may include determining a monetization value for at least one result page produced by the search engine in response to the input query. The method may additionally include assessing whether a search result presentation determined by the search engine requires modification based on the determined monetization value.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is a block diagram illustrating a computerized environment in which embodiments of the invention may be implemented;

FIG. 3 is a block diagram illustrating monetization determination components in accordance with an embodiment of the invention;

FIG. 4 is a block diagram illustrating result modification components in accordance with an embodiment of the invention; and

FIG. 5 is a flowchart illustrating a method in accordance with an embodiment of the invention.

### DETAILED DESCRIPTION OF THE INVENTION

I. System Overview

Embodiments of the invention are directed to a system and method for optimizing web search results based on the monetization value of a query. Embodiments of the system of invention consider the presence of paid advertisements in an advertising system associated with a search engine as a predictor that a user-entered query is commercial. Upon predicting that a query is commercial, embodiments of the system modify search results to better serve the user.

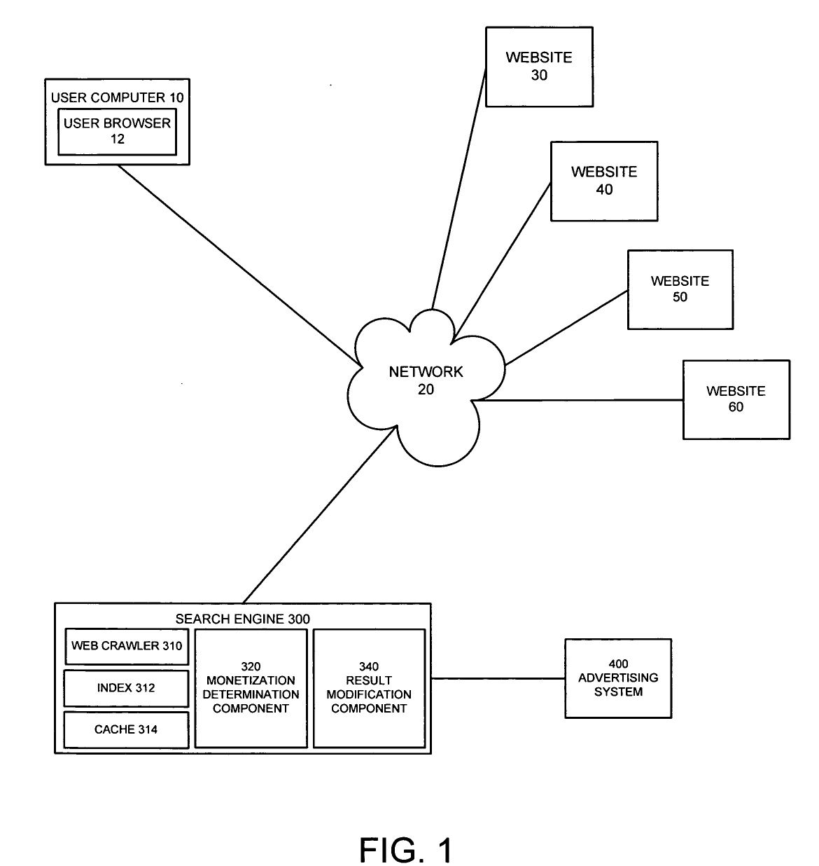

FIG. 1 is a block diagram illustrating a system overview in accordance with embodiments of the invention. A user computer 10 including a user browser 12 may be connected over a network 20 with a search engine 300. The search engine 300 may also access multiple websites 30, 40, 50, 60 over the network 20. The search engine 300 may be connected with an advertising system 400. The search engine 300 may include a web crawler 310, an index 312, and a cache 314 as well as additional components omitted from the drawings for simplicity. The search engine 300 may also include a monetization determination component 320 for determining a monetization value of a keyword, a set of keywords, or a web page and a result modification component 340. The result modification component 340 may modify search results based on the determined monetization. The result modification component 340 may improve ranking in order to avoid spam or excessive advertising and optimize ranking in accordance with the commercial intent. The result modification component 340 may additionally modify presentation format and contextual descriptions to improve the user experience.

Embodiments of the invention provide a system and method for optimizing web search results based on monetization intent. More specifically, embodiments of the system of the invention take the presence of paid advertisements in a query response as a predictor that the query is commercial and then modify the results to better serve the requester.

II. Exemplary Operating Environment

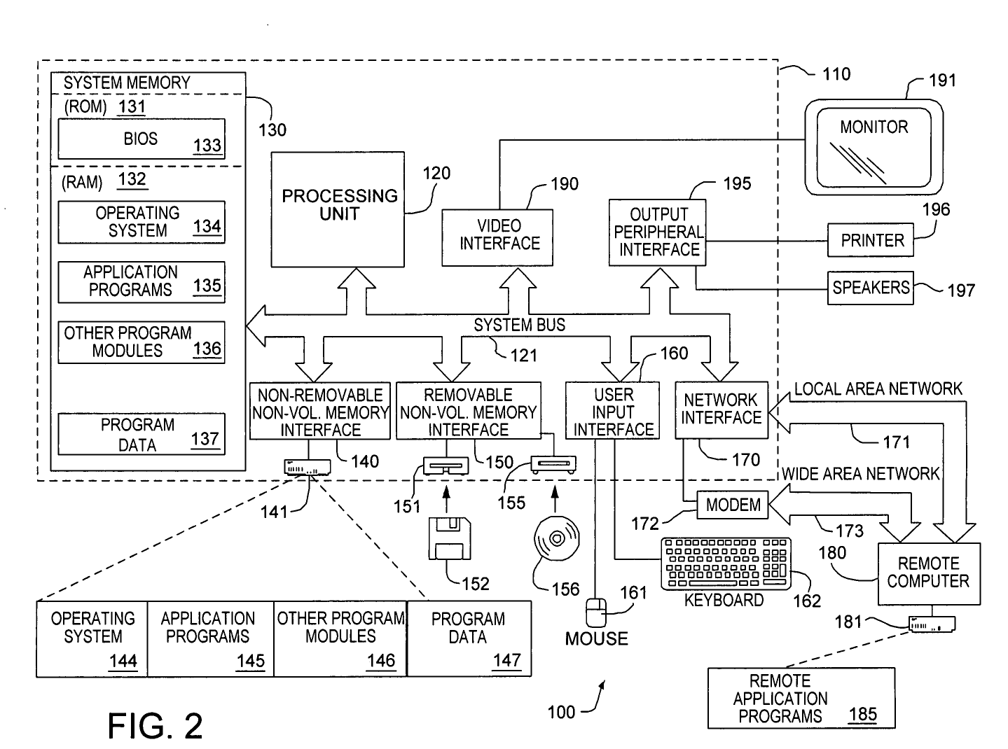

FIG. 2 illustrates an example of a suitable computing system environment 100 on which the system and method for optimizing search results based on monetization intent may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. System and Method of the Invention

As set forth above, FIG. 1 is a block diagram illustrating a system overview in accordance with embodiments of the invention. The search engine 300 may include search components such as the web crawler 310 that indexes results in the index 312. The search engine 300 also may include the monetization determination component 320 and the result modification components 340. The monetization determination component 320 may measure monetization intent based on advertisement data produced from the advertising system 400 as a result of the input query.

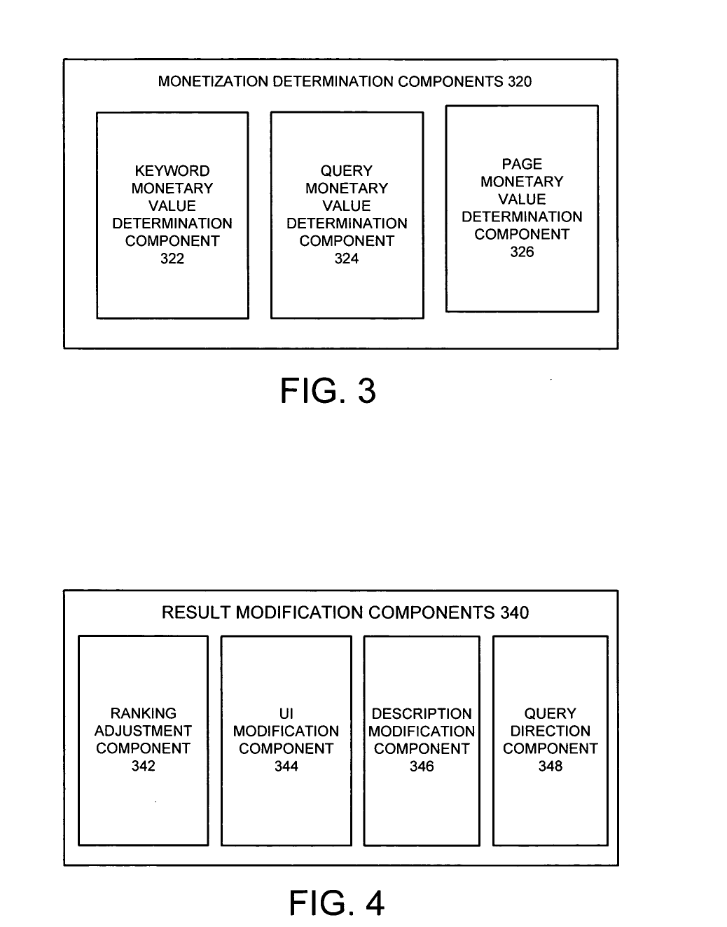

FIG. 3 illustrates details of the monetization determination components 320 in accordance with embodiments of the invention. If the search engine 300 learns that a query is commercial through the use of the monetization determination components 320, then the search engine 300 can react intelligently to present search results. For instance, the search engine 300 can improve rankings and re-format results. To predict that a query or input keywords are commercial, the monetization determination components 320 may rely on lists of words with known monetization or look for presence and dollar amounts of paid advertisements. In the first instance, the monetization determination components 320 may access a monetization list sorted by keyword. In the second instance, the monetization determination components 320 may determine if monetization is present based on the number of advertisements produced, or based on a threshold bid sum or bid average, or based on a combination of the these factors. Accordingly, the monetization determination components 320 may include a keyword monetary value determination component 322 and a query monetary value determination component 324.

The keyword monetary value determination component 322 may determine a monetary value for an input term. The query monetary value determination component 324 may combine the term monetary value determinations of the keyword monetary value determination component 322 in an appropriate manner to determine a query monetary value. As set forth above, the keyword and query monetary value determination component 324 may look up or calculate the monetary value by accessing the dollar amounts bid on the keywords through the advertising system 400 or through one or more partners or partner advertising systems.

The monetization determination components 320 may also include a page monetary value determination component 326. The page monetary value determination component 326 may calculate the monetary value of a resultant page generated by the search engine 300 based on the monetary value of a term or query as determined by the above-identified components. As will be further explained below, the result modification components 340 may use the monetary value of the page, either in conjunction with the monetary value of the query or the query itself, to optimize the results.

FIG. 4 illustrates details of the result modification components 340 that operate to modify results based on monetization determination. If the monetary value determination components 320 have determined a monetary value for a query, the result modification components 340 may then use that monetary value to optimize query results. The result modification components 340 may include a ranking adjustment component 342, a UI modification component 344, a description modification component 346, and a query direction component 348.

The ranking adjustment component 342 may adjust the rankings of results based on the determined query monetization value. If the monetization determination components 320 determine that a query has a high monetization value and is therefore commercial, the ranking adjustment component 342 may operate on the generated results to give commercial results or resultant pages having a high monetization value higher rankings and bring them to the top and give non-commercial results a lower ranking and therefore list them at the bottom.

The ranking adjustment component 342 may segment queries by their monetary worth and tune the weights of the ranking features used for ranking in each segment separately. The ranking adjustment component 342 may use the monetary value of the query terms to scale the weights of ranking features that use terms. For example, the ranking adjustment component 342 may weight terms that have a low monetary value as more important to relevance than those with a high monetary value.

The ranking adjustment component 342 may maintain two parameter files for scoring. A first parameter file may score results when a query has a low monetization value and a second parameter file may be used to score results when a query has a high monetization value.

As set forth above, the monetary value of a resultant page may be calculated by the page monetary value determination component 326. Accordingly, using the monetary value of the page, optionally in conjunction with the monetary value of a query or just a query itself, the ranking adjustment component 342 may optimize the results. For example, the ranking adjustment component 342 may weight monetarily low value pages higher for monetarily low ranked queries. The ranking adjustment 342 may weight monetarily high value pages lower in order to reduce delivery of an excessive number of advertisements to the user.

In a further embodiment, the ranking adjustment component 342 may apply monetary value in static or prior rank. The ranking adjustment component 342 may operate based on the monetization value of the input keyword or query. If a query has a low monetization value and the user is not likely to be seeking purely commercial information, the ranking adjustment component 342 may operate to avoid producing spam or high monetization value pages as high ranking results in order to improve the user experience. The ranking adjustment component 342 can calculate prior relevance of a result page given the determined monetization value of the page. Since pages having extremely high monetization value are often spam pages, pages having a certain range of high monetary values are typically not worth much as search results. Thus, the ranking adjustment component 342 may lower the rank of pages having a monetization value above a pre-set threshold. If the resultant page has a reasonable monetization value that falls between the upper threshold and another lower threshold, the ranking adjustment component 342 may allow the page rank to remain. Finally, if the page has little or no monetization value, the relevance may be raised, as the page is not likely to be a spam page.

The UI modification component 344 may modify the UI to reflect the commercial nature of a query. If the monetization determination components 320 have already determined that a query has a high monetization value, the UI modification component 344 can present a page having the appearance of a shopping page, for example, by changing the appearance of the UI layout by showing thumbnails or by bolding a product name in title.

The description modification component 346 may modify the contextual descriptions for queries having a high monetization value. For instance, the description modification component 346 may highlight price, date, and other high value data points for monetization queries. The description modification component 346 may add more description instead of just one line or further modify contextual descriptions.

The query direction component 348 may make federation decisions for monetization queries. For example, the query direction component 348 may send the query to a shopping site or product site for real time data. The query direction component 348 may want to provide access to special data sources. For instance, an input query of “Las Vegas” may cause the query direction component 348 to access “Expedia.com” to provide access to prices for hotel rooms or flights. When commercial intent is known, the query description component 348 may pull in such sources as travel related websites or shopping related web sites to get specific results.

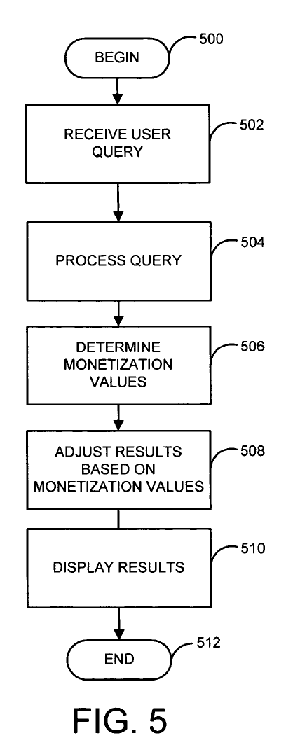

FIG. 5 is a flow chart illustrating a method in accordance with embodiments of the invention. The method begins in step 500 and the search engine 300 receives a query in step 502. In step 502, the search engine 300 processes the query. In step 506, the monetization determination component 320 determines monetization values of keywords, the entire query, or resultant pages. In step 502, the result modification component 340 modifies results if required based on monetization values. In step 510, the search engine 300 displays the results and the method ends in step 512.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for implementing a search engine for producing search results in response to an input query transmitted to the search engine, the input query including at least one keyword, the method comprising:
determining a query monetization value for the input query; and
assessing whether a search result presentation determined by the search engine requires modification based on the determined query monetization value.

2. The method of claim 1, wherein determining a query monetization value comprises determining the value of at least one keyword based on a keyword monetization list.

3. The method of claim 1, wherein determining a query monetization value comprises determining the value of at least one keyword based on bids for the at least one keyword contained within an advertising system.

4. The method of claim 1, wherein assessing whether modification is required comprises comparing the query monetization value to at least one pre-set threshold value.

5. The method of claim 4, further comprising determining that the user input query is a commercial query if the user input query has a query monetization value above the pre-set threshold value.

6. The method of claim 5, further comprising modifying a user interface presented to the user if the query is commercial.

7. The method of claim 5, further comprising modifying result descriptions if the query is commercial.

8. The method of claim 5, further comprising automatically providing user access to selected sources of information if the query is commercial.

9. The method of claim 1, further comprising modifying search result rankings based on the determined monetization value.

10. A system for implementing a search engine for producing search results in response to an input query transmitted to the search engine, the input query including at least one keyword, the system comprising:
monetization determination components for determining a monetization value of at least one of the input query and result pages produced by the search engine; and
result modification components for modifying search results produced by the search engine based on the determined monetization value.

11. The system of claim 10, wherein the monetization determination components comprise a keyword monetary value determination component and a query monetary value determination component.

12. The system of claim 11, wherein the keyword monetary value determination component and the query monetary value determination component determine monetization value based on a keyword monetization list.

13. The system of claim 11, wherein the keyword monetary value determination component and the query monetary value determination component determine monetization value based on bids contained within an advertising system.

14. The system of claim 10, further comprising a page monetization value determination component for determining a monetization value of at least one result page and a ranking adjustment component for ranking result pages based on monetization value.

15. The system of claim 10, wherein the result modification components comprise a ranking adjustment component for adjusting result ranking based on the determined monetization value.

16. The system of claim 10, wherein the result modification components further comprise a user interface modification component for modifying a user interface presented to the user if the query has a monetization value above a threshold value.

17. The system of claim 10, wherein the result modification components further comprise a description modification component for modifying a contextual description presented to the user if the query has a monetization value above a threshold value.

18. The system of claim 10, wherein the result modification components further comprise a query direction component for providing access to selected resources if the query has a monetization value above a threshold value.

19. A method for implementing a search engine for producing search results in response to an input query transmitted to the search engine, the input query including at least one keyword, the method comprising:
determining a monetization value for at least one result page produced by the search engine in response to the input query; and
assessing whether a search result presentation determined by the search engine requires modification based on the determined monetization value.

20. The method of claim 19, further comprising determining whether the result page monetization value exceeds a pre-set threshold and lowering a ranking of the result page if it exceeds the pre-set threshold.
